(19) United States
(12) Patent Application Publication
(10) Pub. No.: US 2012/0259467 A1
(43) Pub. Date: Oct. 11, 2012

(54) CONTROLLING A TOOL

(76) Inventors: Robert Bell, Aberdeen (GB); Lisa Zardoni, Aberdeen (GB)

(21) Appl. No.: 13/443,543

(22) Filed: Apr. 10, 2012

(30) Foreign Application Priority Data
Apr. 11, 2011 (EP) 11161922.7

(51) Int. Cl. G05B 15/02

(52) U.S. Cl. 700/275

(57) ABSTRACT

A control apparatus for a tool comprising features for engaging with corresponding features on an object, the control apparatus comprising an identifier configured to provide information relating to the tool, a reader configured to read the identifier, and a processor in communication with the reader and configured to process the information relating to the tool and to control the tool.

### BACKGROUND OF THE INVENTION

1. Field of the Invention

Embodiments of the present invention relate to a control apparatus for a tool and, more particularly, a remotely operated vehicle (ROV) tool to operate a valve in a subsea Christmas tree (and other similar subsea constructions) installation used in hydrocarbon fluid extraction.

2. Description of the Prior Art

A subsea Christmas tree installation comprises a plurality of valves, which could be located directly over a wellhead. A great number of valves are typically found on such an installation, some of which are used to control chemical and additive injection. As a result of the extreme depths at which these valves are pressed into service, they can be operated by a ROV. To do so, an arm of the ROV is provided with a tool which must enter a receptacle—a ROV docking unit such as a ROV bucket—to operate the valve.

In currently available systems, as shown in FIG. 1, a ROV operator located at the surface operates a computer connected to the ROV to control the ROV. In order to facilitate engagement with a ROV tool, all subsea valves have a ROV bucket which receives the ROV tool. ROV buckets must be designed to conform to industry specifications. To maintain the same ROV interface and prevent frequent tool changes during operations, often all valves are interfaced to the tool through the same ISO 13628-8 bucket type.

Once the ROV tool has engaged with the ROV bucket on the Christmas tree the ROV operator sets the maximum torque value which may be applied to the ROV tool. Maximum torque values for valves are normally specified in the equipment operation and maintenance (O&M) manual and, depending on the valve selected, the operator will set the maximum torque to be applied to the specific valve.

Problems have arisen in the past because the ROV buckets designed in accordance with ISO 13628-8 allow for a maximum operating torque which is considerably higher than the torque-to-damage limit of some subsea valves. If the maximum torque set by the operator is not accurate, the ROV tool can, in theory, apply a torque far greater than the valve can tolerate. If a valve is damaged subsea, recovery of the equipment to surface to fix the problem will be required, causing costly operations downtimes.

The ISO standard recommends using differently shaped buckets for valves dependent on a valve's maximum torque. The use of differently shaped buckets leads to a higher number of ROV tools required for the same tree and will require the ROV to be able to exchange the various tools. This may require bringing the ROV to the surface, which increases costs due to increased downtime of the equipment. Alternatively, it may require more complicated equipment which is capable of exchanging tools subsea, which results in more efficient operations, but also more costly equipment.

It is the object of the present invention to overcome some of the problems of the prior art, or at least to provide an alternative to the prior art systems.

### BRIEF SUMMARY OF THE INVENTION

According to an embodiment of the present invention, there is provided a control apparatus for a tool comprising features for engaging with corresponding features on an object. The control apparatus comprises an identifier configured to provide information relating to the tool, a reader configured to read the identifier, and a processor in communication with the reader and configured to process the information relating to the tool and to control the tool.

According to another embodiment of the present invention, there is provided a tool comprising engaging features for engaging with corresponding features on an object. The tool comprising a reader configured to read an identifier configured to provide information relating to the tool, and a processor in communication with the reader and configured to process the information relating to the tool and to control the tool.

According to another embodiment of the present invention, there is provided a method of controlling a tool, wherein the tool comprises engaging features for engaging with corresponding features on an object. The method comprises reading, with a reader, information provided by an identifier, the information relating to the tool, processing the information provided by the identifier to determine the correct operation of the tool, and controlling the tool based on the information provided by the identifier.

### BRIEF DESCRIPTION OF THE DRAWINGS

Embodiments of the present invention will be more apparent to those skilled in the art upon reading the following description with reference to the accompanying drawings, in which:

FIG. 1 shows a schematic view of a prior art system; and

FIG. 2 shows a schematic view of a control apparatus according to an embodiment of the present invention.

### DETAILED DESCRIPTION OF THE INVENTION

According to an exemplary embodiment of the present invention, there is provided a control apparatus for a tool, the tool having features for engaging with corresponding features on an object. The control apparatus comprises an identifier configured to provide information relating to the tool, a reader configured to read the identifier, and a processor in communication with the reader configured to process the information relating to the tool and to control the tool.

In an embodiment of the present invention, the tool is a ROV tool provided on a ROV.

A control apparatus according to embodiments of the present invention offer a significant advantage over currently available systems in that the tool obtains information directly from the object and this is processed by a processor to determine the correct use of the tool. The correct use of the tool may be information relating to the safe operating parameters for the tool. This removes the need for an operator to enter the operating parameters manually and reduces the likelihood of incorrect operating parameters being selected. The identifier may provide the information passively or actively, as will be appreciated by the skilled person. For example, in an embodiment of the present invention, the identifier may be an ID chip and the reader may be a chip reader. Alternatively, the identifier may transmit a signal relating to the operating parameters and the reader may comprise a receiver for receiving the signal. It will be appreciated that a wide variety of identifier and reader may be used within the scope of embodiments of the present invention, the key feature being that the information provided by the identifier is in a form which can be determined by the reader.

The term “associated with” as used herein in relation to the relationship of the reader and the tool means that the reader is provided in such a way that it is capable of reading the information provided by the identifier when the tool approaches or engages with the object. In the case where the tool is a ROV tool, the reader may be provided on the ROV tool, or on the ROV itself, or in any suitable location such that it may “read” the identifier information.

In an embodiment of the present invention, the object comprises a docking unit for the tool.

In an embodiment of the present invention, the docking unit may comprise a docking unit of a valve operated by the tool. The valve may be a subsea valve. The tool is provided with features for engaging with the docking unit of the valve, such features being well-known. The tool can be used to open and/or close the valve as required. The valve may be a rotary valve, or it may be a linear valve, or any other valve as will be appreciated by the skilled person. In an embodiment of the invention the identifier provides information relating to the status of the valve. This information could indicate whether the valve is open, closed, or in some intermediate position, or any other relevant information about the status of the valve. The information obtained from the identifier could be used to generate a log relating to the status and operating parameters of the valve.

It will be appreciated that a valve is only one example of an object which falls within the scope of the present invention. Other objects which can engage with, and be operated by, a tool will also fall within the scope of the embodiments of the present invention, as will be readily understood by the skilled person.

In an embodiment of the present invention the object can be operated in a rotary manner, e.g. a rotary valve, and the identifier provides information relating to the maximum torque which can be supplied to the tool, i.e. the maximum torque which the object can withstand. In the case where the object is a rotary valve, the identifier will provide information relating to the maximum torque which can be supplied to the valve before damage. The information is then processed by the processor, which controls the tool to limit the torque applied to below the maximum level. This offers a significant advantage over prior art systems as there is no human input in setting the torque values, which reduces the likelihood of damage to the valve. Damage to valves, particularly in a subsea environment, results in downtime while the equipment is repaired, which is costly and time consuming.

In an embodiment of the invention, the tool is a ROV tool provided on a ROV, wherein the processor is located within the ROV. In an alternative embodiment of the invention, in which the object is located in a subsea environment, e.g. a subsea valve, the processor is located at the surface, or in another location remote from the tool.

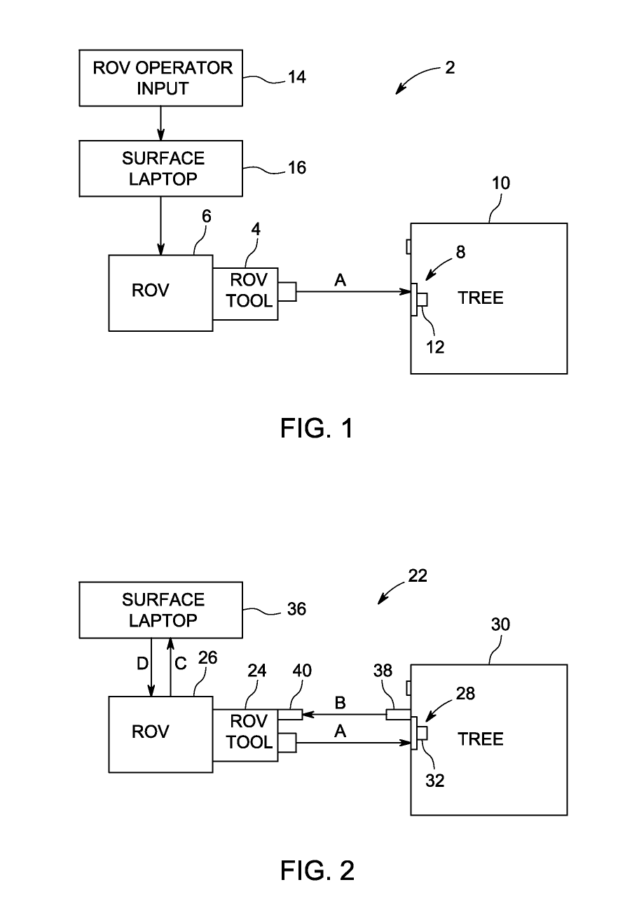

Referring firstly to FIG. 1, which shows a schematic representation of a prior art control apparatus 2 for a remotely operated vehicle (ROV) tool 4. The ROV tool 4 is provided on a ROV 6 and is used to operate a rotary valve 8 on a subsea Christmas tree installation 10. The subsea Christmas tree installation 10 will have a large number of valves, but for clarity only one is shown.

In order to facilitate engagement of the ROV tool 4 with the valve 8, the valve 8 is provided within a docking unit in the form of a ROV bucket 12. The ROV bucket 12 is shaped to receive the ROV tool 4 and is located on the Christmas tree 10. The ROV bucket 12 functions as a dock and ensures that only a ROV tool 4 of the appropriate shape is able to engage with the valve 8 when the ROV tool 4 is brought into engagement with the ROV bucket 12, as indicated by arrow A. However, as noted above, the same ROV bucket 12 is currently used on most types of valve 8 to maintain the same interface to the ROV tool 4, which is normally supplied by a third party.

An operator located at the surface controls the ROV 6 by an input 14. The operator identifies the maximum torque value of the particular rotary valve 8 by consulting the operation and maintenance (O&M) manual for the valve 8. The operator then inputs the maximum torque value for the valve 8 into a surface laptop computer 16, which sends instructions to the ROV tool 4 limiting the maximum torque which can be applied to the ROV tool 4 for this particular valve 8. The torque limitation is done by limiting the pressure supplied to the hydraulic input of the ROV tool 4.

Problems can arise due to the fact that the same ROV bucket 12 is generally used for a variety of valves 8 having different maximum torques. The maximum operating torque of the ROV bucket 12 may be considerably higher than the maximum torque limit of some subsea valves. If the operator 14 inputs an incorrect maximum torque, the ROV tool 4 can apply a torque far greater than the valve 8 can tolerate. This can cause damage to the valve 8, which may result in downtime while the valve 8 is brought to the surface for repair.

Turning now to FIG. 2, which shows a schematic representation of a control apparatus 22 for a ROV tool 24 according to an embodiment of the present invention, the basic construction of the ROV tool 24, the ROV 26, the valve 28, ROV bucket 32, and the Christmas tree installation 30 are similar to those described in relation to the system of FIG. 1 and like parts use the same numbering increased by 20. As with the apparatus of FIG. 1, the ROV tool 24 is brought into engagement with the ROV bucket 32 by moving it in a direction as indicated by the arrow A.

An identification (ID) chip 38 is provided on the ROV bucket 32. The ID chip 38 provides information about the valve 28, such as the current status of the valve 28, i.e. open, closed or in an intermediate position, and the maximum torque which can be applied to the valve 28 to change the valve's position. It will be easily understood that other information about the valve 28 could also be provided by the ID chip 38.

A chip reader 40 is provided on the ROV tool 24. When the chip reader 40 comes within range of the ID chip 38 (the range to be determined by the selection of the ID chip/chip reader combination), the chip reader 40 automatically detects the ID chip 38 and reads the information relating to the valve status, maximum torque, etc., as indicated by the arrow B. The information is then sent to a surface laptop (indicated by arrow C) which processes the information obtained from the ID chip 38 and sends a signal to the ROV tool 24 to limit the maximum torque which will be applied to the valve 28 by the ROV tool 24. The torque limitation is done by limiting the pressure supplied to the hydraulic input of the ROV tool 24. In an alternative embodiment the processor may be located within the ROV tool 24 or ROV 26.

The information obtained from the ID chip 38 may be used to generate a log of valve position, maximum torque, and any other relevant information obtained from the ID chip 38. Compilation of the information obtained from a plurality of valves on the Christmas tree 30 permits the generation of an activity log of on-going operations on the tree and increases awareness at a global level. The activity log may be communicated to a production platform on the surface for further analysis.

The present invention has been described with reference to a ROV tool 24 for use with a subsea valve 28. However, this is merely one example and the present invention could be used with any ROV tool which has features for engaging with an object. Furthermore, the embodiments of the present invention are not limited to subsea applications.

What is claimed is:

1. A control apparatus for a tool comprising features for engaging with corresponding features on an object, the control apparatus comprising:
an identifier configured to provide information relating to the tool;
a reader configured to read the identifier; and
a processor in communication with the reader and configured to process the information relating to the tool and to control the tool.

2. The control apparatus of claim 1, wherein the tool is a remotely operated vehicle tool on a remotely operated vehicle.

3. The control apparatus of claim 1, wherein the identifier is an identification chip and the reader is a chip reader.

4. The control apparatus of claim 2, wherein the identifier is an identification chip and the reader is a chip reader.

5. The control apparatus of claim 1, wherein the object comprises a docking unit for the tool.

6. The control apparatus of claim 5, wherein the docking unit comprises a docking unit of a valve.

7. The control apparatus of claim 6, wherein the valve is a subsea valve.

8. The control apparatus of claim 6, wherein the identifier provides information relating to the status of the valve.

9. The control apparatus of claim 1, wherein the identifier provides information relating to the maximum torque that can be supplied to the tool.

10. The control apparatus of claim 2, wherein the identifier provides information relating to the maximum torque that can be supplied to the tool.

11. The control apparatus of claim 3, wherein the identifier provides information relating to the maximum torque that can be supplied to the tool.

12. The control apparatus of claim 4, wherein the identifier provides information relating to the maximum torque that can be supplied to the tool.

13. The control apparatus of claim 2, wherein the processor is located within the remotely operated vehicle.

14. The control apparatus of claim 1, wherein the object is located in a subsea environment and the processor is located at the surface.

15. A tool comprising engaging features for engaging with corresponding features on an object, the tool comprising:
a reader configured to read an identifier configured to provide information relating to the tool; and
a processor in communication with the reader and configured to process the information relating to the tool and to control the tool.

16. The tool of claim 15, wherein the tool is a remotely operated vehicle tool.

17. A method of controlling a tool, wherein the tool comprises engaging features for engaging with corresponding features on an object, the method comprising:
reading, with a reader, information provided by an identifier, the information relating to the tool;
processing the information provided by the identifier to determine the correct operation of the tool; and
controlling the tool based on the information provided by the identifier.

18. The method of claim 17, wherein the tool is a ROV tool.

19. The method of claim 17, wherein the object is a docking unit of a valve, wherein the identifier provides information relating to the status of the valve, and wherein the method further comprises obtaining information relating to the status of the valve.

20. The method of claim 17, further comprising generating a log based on the information provided by the identifier.
